(19) United States
(12) Patent Application Publication
(10) Pub. No.: US 2026/0307159 A1
(43) Pub. Date: Oct. 8, 2026

(54) Spot Face Tool, Assembly and Method

(71) Applicant: EADS Cooling Solutions, LLC, Houston, TX (US)

(72) Inventor: Colin Shoun, Catoosa, OK (US)

(21) Appl. No.: 19/098,109

(22) Filed: Apr. 2, 2025

(51) Int. Cl. B23C 3/13

(52) U.S. Cl. CPC B23C 3/13

(57) ABSTRACT

A spot face tool assembly and method of use is disclosed. The spot face tool assembly and method for cutting a spot face on a work piece from a perpendicular orientation, such as cutting a spot face surrounding a plughole on a heat exchanger. In some embodiments, the spot face tool assembly includes a spot face connector, shaft assembly and cutter configured to be detachably connected to one another. In some embodiments the spot face connector further includes a pneumatic drill detachably connected to the spot face connector. The spot face connector includes an open front receiving end and a closed back connecting end. The shaft assembly includes a stabilizer, base and shaft. The shaft of the shaft assembly is detachably connected to the open front receiving end of the spot face connector. The cutter detachably connected to the open front receiving end of the spot face connector.

### FIELD OF INVENTION

The invention is in the technical field of spot face tools, assemblies, and methods. The invention pertains generally to hand-held spot face tools used from a perpendicular orientation and for construction and assembly of heat exchangers fabricated from finned tubes.

### BACKGROUND

A heat exchanger is a system used to transfer heat between a source and a fluid. Heat exchangers are used in both cooling and heating processes. The fluids used in a heat exchanger may be separated by a solid wall to prevent mixing or they may be in direct contact. Heat exchangers are widely used in a variety of industries, including but not limited to, automotive, space heating, refrigeration, air conditioning, power stations, chemical plants, petrochemical plants, petroleum refineries, natural-gas processing, and sewage treatment, for example.

In order to increase efficiency, heat exchangers are often designed to maximize the surface area of the wall between the two fluids and to minimize resistance to fluid flow using finned tubes. A finned tube is a tube with fins added to its outside surface to increase the area where heat can be exchanged between the fluid inside the tube and the fluid outside. The fins provide more contact with the outside fluid, which speeds up the exchange of heat and improves the efficiency of the heat exchanger.

To fabricate, construct, repair and maintain finned tube heat exchangers a variety of traditional tools are used. One such traditional tool is a hand-held spot face tool. A spot face tool is a tool used to make a spot face, i.e., a smooth, flat and accurately located surface on a work piece. A spot face is a machined feature in which a certain region of the work piece (a spot) is “faced” providing a smooth, flat accurately located surface. In the fabrication and construction of finned tube heat exchangers, a spot face must be made on the finned tube heat exchanger surrounding the opening or plug hole of the heat exchanger where the finned tubes are positioned, connected, plugged or detachably connected to other component parts of the heat exchanger. This area must be smoothed out to a high degree of precision to prevent leaks and to enable various component parts of the finned tube heat exchanger to be detachably connected, removed, repaired or replaced, for example.

Traditional hand-held spot face tools are configured to be used with the spot face tool and cutter positioned directly above the spot face and going straight down, i.e., from a top-down approach, so that the force applied by the worker to create the spot face is precise, accurately located and evenly distributed. Unfortunately, however, to create a spot face on a finned tube heat exchanger, the spot face must often be cut from a side or perpendicular orientation, i.e., a side-to-side approach, with the worker exerting force outward and from the side of the work piece. Using a traditional spot face tool from a perpendicular or side-to side position or orientation is difficult, inefficient, unstable, and often causes the resulting spot face that is cut on the work piece to be not precise, not accurately located and not evenly distributed. This is because the workers’ hands and body tire more easily when holding the spot face tool out and away from the workers body and as the worker applies force to the spot face tool to cut the spot face on the work site. As the worker holds the spot face tool outward and at a perpendicular or side position in relation to the work piece, the worker more easily tires and may accidentally push the spot face tool at an angle, either upward or downward. Further, because the traditional spot face tool is not securely stabilized on the spot face of the work site and the force applied may be uneven or angled, the spot face is more likely to contain errors, be angled, uneven or not precisely cut. As a result, the spot face must often be corrected, recut, re-finished and redone, sometimes multiple times, in order to properly cut the spot face on the work site. This increases the time and effort needed to cut the spot face, increases the cost, and decreases the safety of the process because it may cause the worker to become more fatigued and to spend more time and effort in making the spot face.

To that end, it would be advantageous to provide an improved spot face tool, assembly and method of use that is configured to be used from a perpendicular or side orientation and which is configured to be stabilized and secured directly on the work piece to improve efficiency, safety and to reduce the cost and effort involved in creating a spot face from a side or perpendicular orientation. In particular, the improved spot face tool, assembly, and method of use is configured for creating a spot face on a plug hole or opening of a finned tube heat exchanger from a side or perpendicular orientation. The improved spot face tool, assembly and method of use disclosed and claimed herein provides substantial, non-obvious benefits, improvements and advantages over traditional spot face tools. The improved spot face tool and method disclosed and claimed herein generally includes a spot face connector, a shaft assembly and a cutter for cutting a spot face on a work piece from a perpendicular orientation. The spot face tool assembly includes a spot face connector having an open front receiving end and a closed back connecting end; a shaft assembly having a stabilizer, base and shaft, the shaft of the shaft assembly detachably connected to the open front receiving end of the spot face connector; and a cutter detachably connected to the open front receiving end of the spot face connector.

In some embodiments, the spot face tool assembly further includes a pneumatic drill detachably connected thereto. For example, a hand-held pneumatic drill, a press, or similar drilling machine (hand-held or stationary) that is detachably connected to the closed back connecting end of the spot face connector. Further, in some embodiments the shaft of the shaft assembly includes one or more groove embedded therein for detachably connecting the shaft assembly to the spot face connector. Further, in some embodiments the stabilizer of the shaft assembly is threaded and in some embodiments the cutter is circular, square or may have a variety of different shapes or configurations.

In some embodiments, the spot face tool assembly includes a spot face connector for detachably connecting a cutter and a pneumatic drill. The spot face connector having an open front receiving end and a closed back connecting end. The open front receiving end having one or more ridge for detachably connecting a cutter thereto and the closed back connecting end for detachably connecting a pneumatic drill. The spot face assembly includes a shaft assembly for stabilizing the spot face tool assembly in a perpendicular position to the work piece. The shaft assembly having a threaded stabilizer, base and shaft. The shaft of the shaft assembly detachably connected to the open front receiving end of the spot face connector. The threaded stabilizer configured to be threaded into a threaded opening on the spot face of the work piece to securely stabilize the spot face tool assembly on the work piece in a perpendicular orientation and to reduce angling of the spot face tool assembly and angling of the spot face cut thereon when a force is applied to the spot face tool assembly to cut the spot face from a perpendicular orientation. The spot face tool assembly also includes a circular cutter for cutting a circular spot face on a work piece, the circular cutter detachably connected to the open front receiving end of the spot face connector. The circular cutter configured for rotating about the spot face connector when the spot face connector is detachably connected to a pneumatic drill. In some embodiments, the work piece is a heat exchanger having a plurality of threaded openings or plug holes. Further, in some embodiments, the shaft assembly is detachably connected to the spot face connector in a fixed position and is not able to rotate in relation to the spot face connector.

In some embodiments, a method of cutting a spot face on a work piece from a perpendicular orientation is disclosed. The method including the step of: (a) providing a spot face tool assembly for cutting a spot face on a work piece from a perpendicular orientation. The spot face tool assembly including a spot face connector having an open front receiving end and a closed back connecting end. The spot face tool having a shaft assembly having a stabilizer, base and shaft. The shaft of the shaft assembly detachably connected to the open front receiving end of the spot face connector. The spot face tool having a cutter detachably connected to the open front receiving end of the spot face connector. The method further including the step of: (b) connecting the closed back connecting end of the spot face connector to a pneumatic drill; (c) inserting the stabilizer of the shaft assembly into an opening on the work piece to stabilize the spot face tool assembly in a perpendicular orientation on the work piece; and (d) cutting a spot face on the work piece from a perpendicular orientation while the stabilizer of the shaft assembly is inserted into the opening on the work piece.

In some embodiments of the method of cutting a spot face on a work piece from a perpendicular orientation the work piece is a heat exchanger and in some embodiments the stabilizer is threaded and the opening or plug hole of the work piece is threaded. Further, in some embodiments of the method of cutting a spot face on a work piece the threaded opening of the spot face is a plug hole of a heat exchanger. Further, in some embodiments of the method of cutting a spot face on a work piece form a perpendicular orientation the shaft assembly is detachably connected to the spot face connector in a fixed position and is not able to rotate in relation to the spot face connector.

The improved spot face tool, assembly and method of use disclosed and claimed herein provides numerous non-obvious benefits and advantages over traditional spot face tools and methods used for creating a spot face from a perpendicular orientation, such as on a finned tube heat exchanger.

### SUMMARY OF THE INVENTION

Exemplary embodiments of the spot face tool, assembly, and method of use are disclosed herein. The spot face tool, assembly and method include various component parts formed from a variety of materials that are configured to be detachably connected to one another, assembled, disassembled, sold as a kit and/or a unitary tool or assembly of component parts for use in making a spot face on a work piece from a perpendicular orientation. In particular, the spot face tool, assembly, and method disclosed herein is configured to be used for making a spot face on a finned tube heat exchanger and in the fabrication, construction, building, engineering, design and fabricating, building, engineering, design and maintenance of finned tube heat exchangers. In some embodiments, the component parts of the spot face tool assembly may be fully or partially assembled while in other embodiments the component parts of the spot face tool assembly may be completely disassembled so that various sized and shaped component parts of the spot face tool assembly may be used to create a custom spot face tool assembly for use with a specific work piece and for the creation of a specific spot face. For example, a spot face connector, shaft assembly and cutter may be selectively chosen by a user to create a custom spot face tool assembly from a plurality and variety of different sized and shaped spot face connector, shaft assembly, and cutter designed and configured for use in cutting a specific sized or shaped spot face on a specific type and size or shape of work piece from a perpendicular orientation.

The improved spot face tool, assembly and method of use disclosed and claimed herein provides substantial, non-obvious benefits, improvements and advantages over traditional spot face tools. The improved spot face tool and method disclosed and claimed herein generally includes a spot face connector, a shaft assembly and a cutter for cutting a spot face on a work piece from a perpendicular orientation. The spot face tool assembly includes a spot face connector having an open front receiving end and a closed back connecting end; a shaft assembly having a stabilizer, base and shaft, the shaft of the shaft assembly detachably connected to the open front receiving end of the spot face connector; and a cutter detachably connected to the open front receiving end of the spot face connector.

In some embodiments, the spot face tool assembly further includes a pneumatic drill detachably connected to the closed back connecting end of the spot face connector. For example, a hand-held pneumatic drill, a press, or similar drilling machine (hand-held or stationary) that is detachably connected to the closed back connecting end of the spot face connector. Further, in some embodiments the shaft of the shaft assembly includes one or more groove embedded therein for detachably connecting the shaft assembly to the spot face connector. Further, in some embodiments the stabilizer of the shaft assembly is threaded and in some embodiments the cutter is circular, square or may have a variety of different shapes or configurations.

In some embodiments, the spot face tool assembly includes a spot face connector for detachably connecting a cutter and a pneumatic drill. The spot face connector having an open front receiving end and a closed back connecting end. The open front receiving end having one or more ridge for detachably connecting a cutter thereto and the closed back connecting end for detachably connecting a pneumatic drill. The spot face assembly includes a shaft assembly for stabilizing the spot face tool assembly in a perpendicular position to the work piece. The shaft assembly having a threaded stabilizer, base and shaft. The shaft of the shaft assembly detachably connected to the open front receiving end of the spot face connector. The threaded stabilizer configured to be threaded into a threaded opening on the spot face of the work piece to securely stabilize the spot face tool assembly on the work piece in a perpendicular orientation and to reduce angling of the spot face tool assembly and angling of the spot face cut thereon when a force is applied to the spot face tool assembly to cut the spot face from a perpendicular orientation. The spot face tool assembly also includes a circular cutter for cutting a circular spot face on a work piece, the circular cutter detachably connected to the open front receiving end of the spot face connector. The circular cutter configured for rotating about the spot face connector when the spot face connector is detachably connected to a pneumatic drill. In some embodiments, the work piece is a heat exchanger having a plurality of threaded openings or plug holes. Further, in some embodiments, the shaft assembly is detachably connected to the spot face connector in a fixed position and is not able to rotate in relation to the spot face connector.

In some embodiments, a method of cutting a spot face on a work piece from a perpendicular orientation is disclosed. The method including the steps of: (a) providing a spot face tool assembly for cutting a spot face on a work piece from a perpendicular orientation. The spot face tool assembly including a spot face connector having an open front receiving end and a closed back connecting end. The spot face tool having a shaft assembly having a stabilizer, base and shaft. The shaft of the shaft assembly detachably connected to the open front receiving end of the spot face connector. The spot face tool having a cutter detachably connected to the open front receiving end of the spot face connector. The method further including the step of: (b) connecting the closed back connecting end of the spot face connector to a pneumatic drill; (c) inserting the stabilizer of the shaft assembly into an opening on the work piece to stabilize the spot face tool assembly in a perpendicular orientation on the work piece; and (d) cutting a spot face on the work piece from a perpendicular orientation while the stabilizer of the shaft assembly is inserted into the opening on the work piece.

In some embodiments of the method of cutting a spot face on a work piece from a perpendicular orientation the work piece is a heat exchanger and in some embodiments the stabilizer is threaded and the opening or plug hole of the work piece is threaded. Further, in some embodiments of the method of cutting a spot face on a work piece the threaded opening of the spot face is a plug hole of a heat exchanger. Further, in some embodiments of the method of cutting a spot face on a work piece form a perpendicular orientation the shaft assembly is detachably connected to the spot face connector in a fixed position and is not able to rotate in relation to the spot face connector.

The improved spot face tool, assembly and method of use disclosed and claimed herein provides numerous non-obvious benefits and advantages over traditional spot face tools and methods used for creating a spot face from a perpendicular orientation, such as on a finned tube heat exchanger.

It should be understood that each of the component parts of the spot face tool assembly and method of use are configured to be selectively and detachably connected, disconnected, and used interchangeably with a variety of different sized and shaped component parts to create a customizable, modular, and selectively interchangeable tool, system and method. In this way, a user may, select from a range of differently configured, sized, and shaped component parts of the spot face tool assembly and method to customize the spot face tool assembly and method. Thus, numerous configurations and methods of use are contemplated and may be selectively arranged and customized for use in making a spot face on a work piece from a perpendicular or side orientation, including specifically, making a spot face on a finned tube heat exchanger from a perpendicular or side orientation and by stabilizing the spot face tool assembly on the opening or plug hole for finned tubes of the finned tube heat exchanger. Further, the spot face tool assembly and method may be used in combination with a variety of different tools, assemblies, fabrication machines, systems, and component parts.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a perspective view of a spot face connector (120) of a spot face tool assembly (100) in accordance with the inventive concepts disclosed herein.

FIG. 2 is a sectional view of a spot face connector (120) of a spot face tool assembly (100) in accordance with the inventive concepts disclosed herein.

FIG. 3 is an exploded view of a spot face tool assembly (100) in accordance with the inventive concepts disclosed herein.

FIG. 4 is a perspective view of a spot face connector (120) of a spot face tool assembly (100) in accordance with the inventive concepts disclosed herein.

FIG. 5 is a sectional view of a spot face connector (120) of a spot face tool assembly (100) in accordance with the inventive concepts disclosed herein.

FIG. 6 is a perspective view of a spot face connector (120) of a spot face tool assembly (100) in accordance with the inventive concepts disclosed herein.

FIG. 7 is a sectional view of a spot face connector (120) of a spot face tool assembly (100) in accordance with the inventive concepts disclosed herein.

FIG. 8 is a perspective view of a shaft assembly (140) of a spot face tool assembly (100) in accordance with the inventive concepts disclosed herein.

FIG. 9 is a perspective view of a spot face tool assembly (100) in accordance with the inventive concepts disclosed herein.

FIG. 10 is a perspective view of a shaft assembly (140) of a spot face tool assembly (100) positioned on a spot face (105) of a work piece (110) in accordance with the inventive concepts disclosed herein.

FIG. 11 is a perspective view of a shaft assembly (140) of a spot face tool assembly (100) positioned on a spot face (105) of a work piece (110) in accordance with the inventive concepts disclosed herein.

FIG. 12 is a perspective view of a spot face assembly (100) positioned on a spot face (105) of a work piece (110) in accordance with the inventive concepts disclosed herein.

FIG. 13 is a perspective view of a shaft assembly (140) detachably connected to a cutter (160) of a spot face tool assembly (100) positioned on a spot face (105) of a work piece (110) in accordance with the inventive concepts disclosed herein.

FIG. 14 is a perspective view of a spot face tool assembly (100) detachably connected to a pneumatic drill (103) in accordance with the inventive concepts disclosed herein.

FIG. 15 is a perspective view of a spot face tool assembly (100) detachably connected to a pneumatic drill (103) in accordance with the inventive concepts disclosed herein.

FIG. 16 is a diagram of a method (400) of cutting a spot face (105) on a work piece (110) in accordance with the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

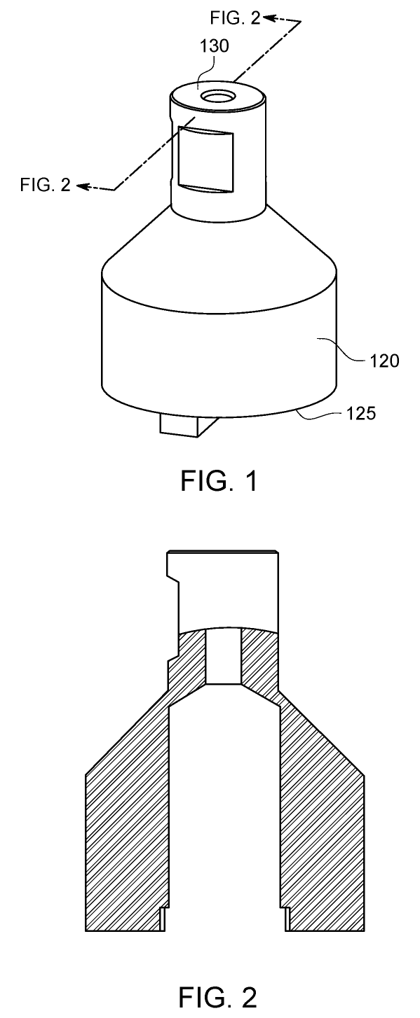

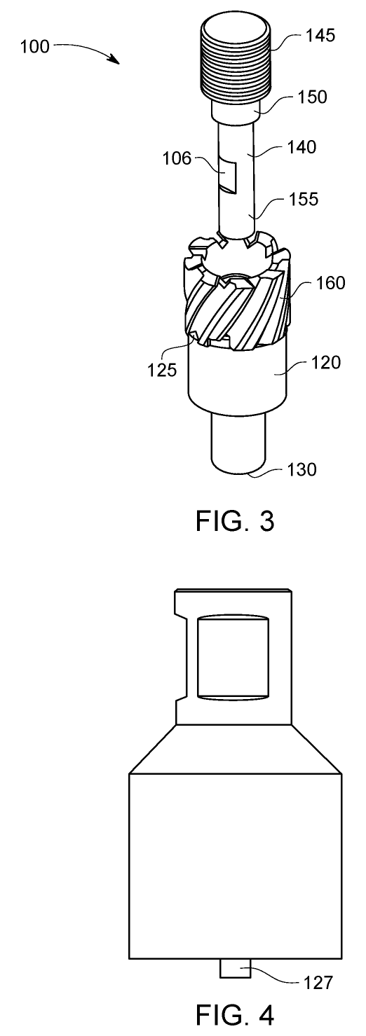

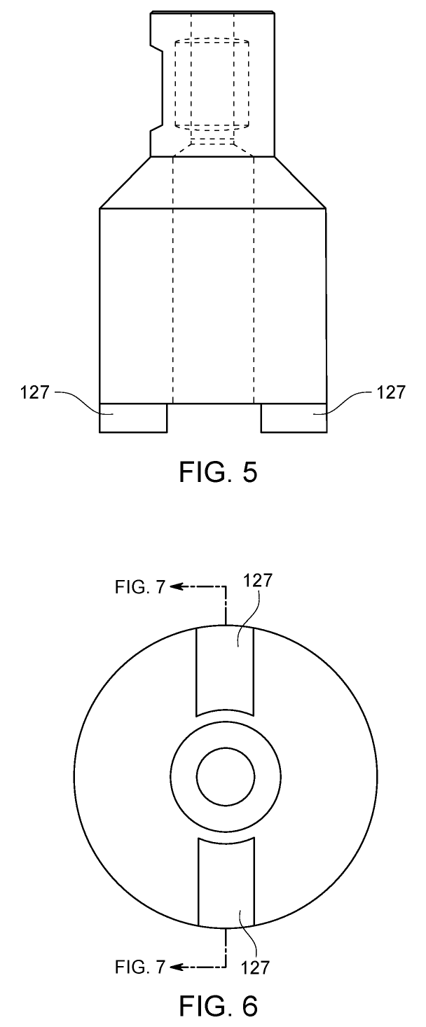

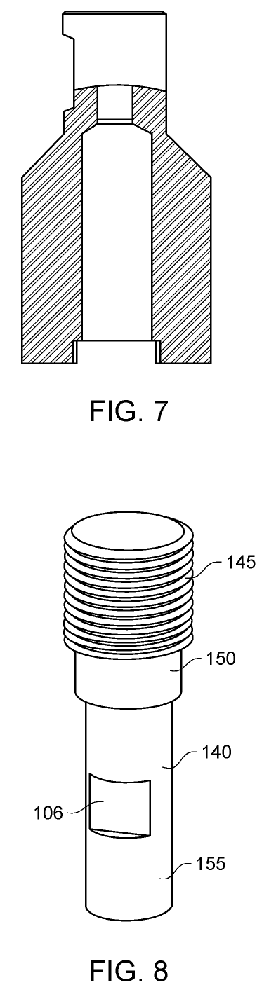

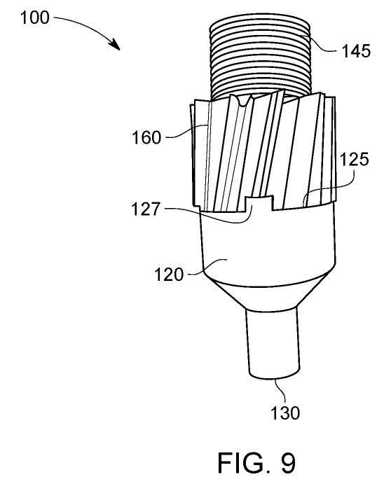

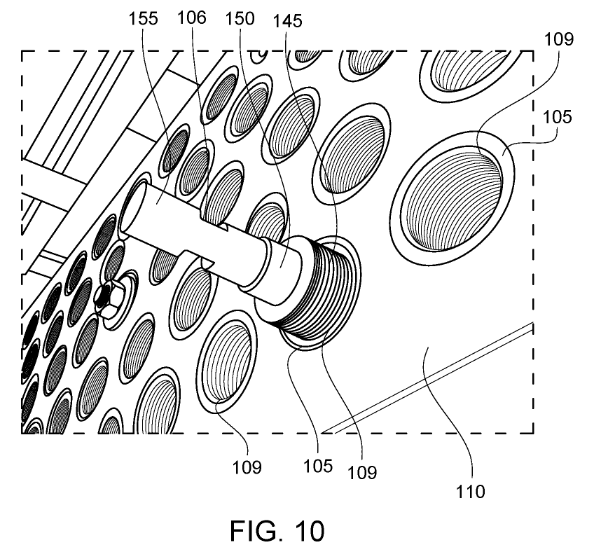

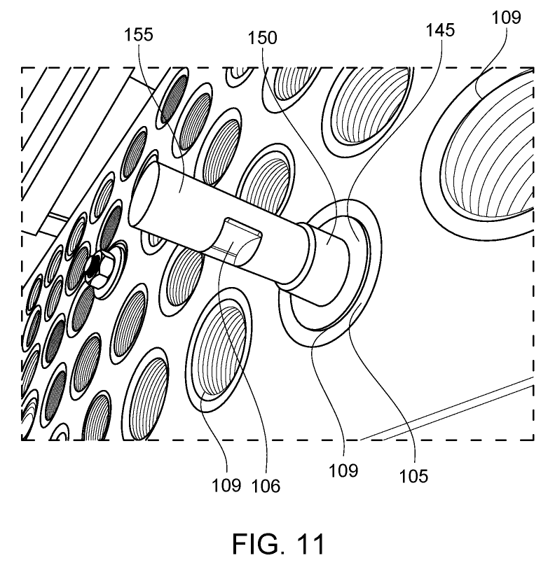

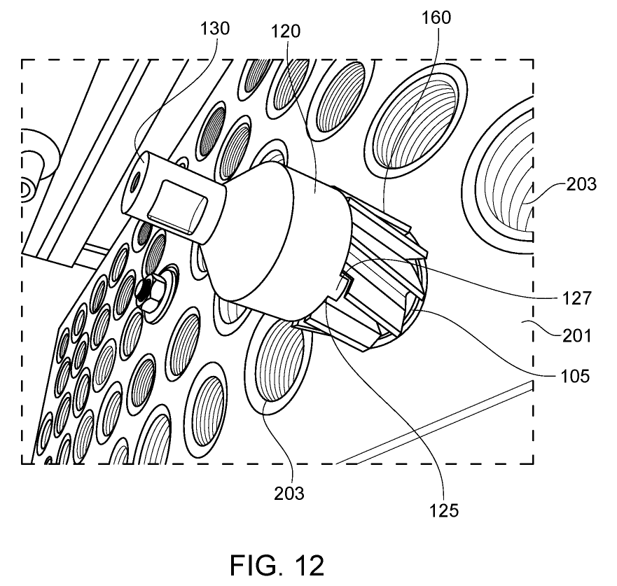

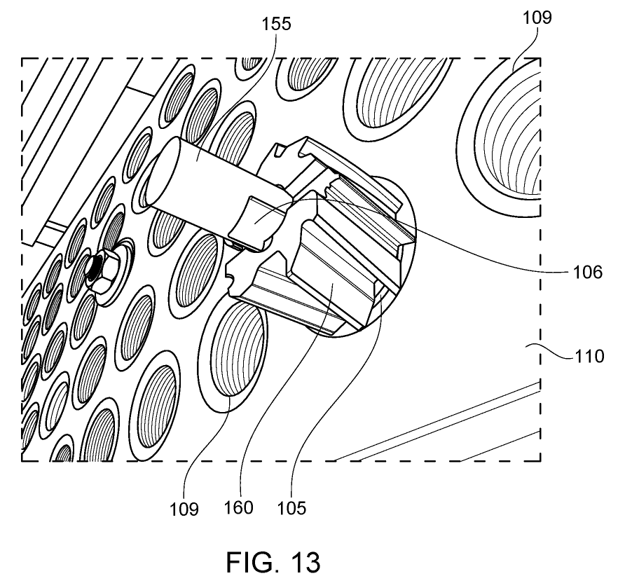

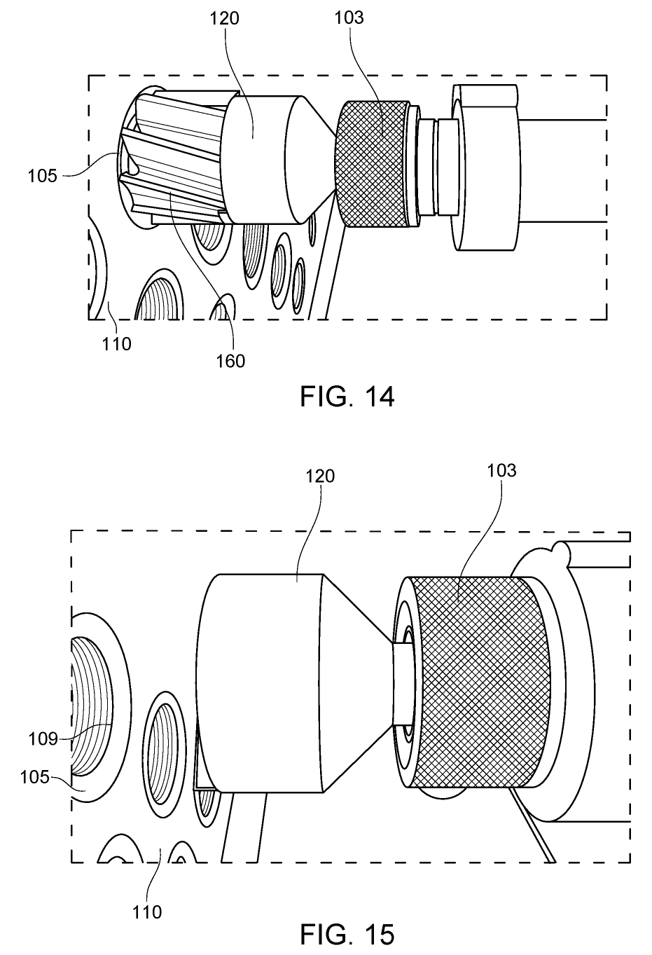

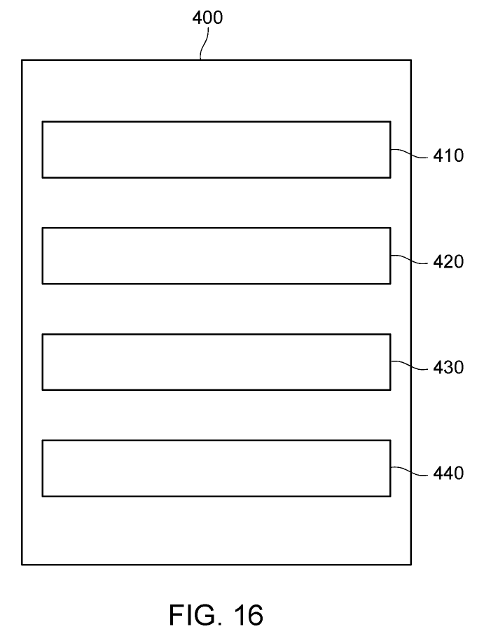

Referring now to FIGS. 1-16, shown therein is a spot face tool assembly (100) and method (400) for cutting a spot face (105) on a work piece (110) from a perpendicular orientation. FIG. 1 is a perspective view of a spot face connector (120) of a spot face tool assembly (100) in accordance with the inventive concepts disclosed herein. FIG. 2 is a sectional view of a spot face connector (120) of a spot face tool assembly (100) in accordance with the inventive concepts disclosed herein. FIG. 3 is an exploded view of a spot face tool assembly (100) in accordance with the inventive concepts disclosed herein. FIG. 4 is a perspective view of a spot face connector (120) of a spot face tool assembly (100) in accordance with the inventive concepts disclosed herein. FIG. 5 is a sectional view of a spot face connector (120) of a spot face tool assembly (100) in accordance with the inventive concepts disclosed herein. FIG. 6 is a perspective view of a spot face connector (120) of a spot face tool assembly (100) in accordance with the inventive concepts disclosed herein. FIG. 7 is a sectional view of a spot face connector (120) of a spot face tool assembly (100) in accordance with the inventive concepts disclosed herein. FIG. 8 is a perspective view of a shaft assembly (140) of a spot face tool assembly (100) in accordance with the inventive concepts disclosed herein. FIG. 9 is a perspective view of a spot face tool assembly (100) in accordance with the inventive concepts disclosed herein. FIG. 10 is a perspective view of a shaft assembly (140) of a spot face tool assembly (100) positioned on a spot face (105) of a work piece (110) in accordance with the inventive concepts disclosed herein. FIG. 11 is a perspective view of a shaft assembly (140) of a spot face tool assembly (100) positioned on a spot face (105) of a work piece (110) in accordance with the inventive concepts disclosed herein. FIG. 12 is a perspective view of a spot face assembly (100) positioned on a spot face (105) of a work piece (110) in accordance with the inventive concepts disclosed herein. FIG. 13 is a perspective view of a shaft assembly (140) detachably connected to a cutter (160) of a spot face tool assembly (100) positioned on a spot face (105) of a work piece (110) in accordance with the inventive concepts disclosed herein. FIG. 14 is a perspective view of a spot face tool assembly (100) detachably connected to a pneumatic drill (103) in accordance with the inventive concepts disclosed herein. FIG. 15 is a perspective view of a spot face tool assembly (100) detachably connected to a pneumatic drill (103) in accordance with the inventive concepts disclosed herein. FIG. 16 is a diagram of a method (400) of cutting a spot face (105) on a work piece (110) in accordance with the inventive concepts disclosed herein.

As shown therein, the spot face tool assembly (100) includes a spot face connector (120) having an open front receiving end (125) and a closed back connecting end (130). The spot face tool assembly (100) further includes a shaft assembly (140) having a stabilizer (145), base (150) and shaft (155). The shaft (155) of the shaft assembly (140) detachably connected to the open front receiving end (125) of the spot face connector (120). The spot face tool assembly (100) further includes a cutter (160) detachably connected to the open front receiving end (125) of the spot face connector (120). The spot face tool assembly (100), including the spot face connector (120), shaft assembly (140) and cutter (160) may each be constructed from any material of sufficient strength necessary for the intended purpose of the spot face assembly (100) and necessary to maintain the structural integrity of the spot face tool assembly (100) when in use. For example, the spot face tool assembly (100), including the spot face connector (120), shaft assembly (140) and cutter (160) may each be constructed from metals such as steel, carbon steel, alloy steel, stainless steel, alloys or other metals, combinations thereof and the like and non-metals such as, plastics, polycarbonate, impact resistant nylon, carbon fiber, polymers, resins, ceramics, composite materials, combinations thereof and the like. It should be understood that the spot face tool assembly (100), including the spot face connector (120), shaft assembly (140) and cutter (160), may each be constructed from the same or different materials. For example, the spot face connector (120) may be constructed from stainless steel, while the shaft assembly (140) is constructed from carbon steel, while the cutter (160) may be constructed from stainless steel, for example.

The spot face tool assembly (100), including the spot face connector (120), shaft assembly (140) and cutter (160), are each configured to be detachably connected to one another and each of the spot face connector (120), shaft assembly (140) and cutter (160) may be constructed in a variety of different sizes, shapes and configurations for use on a variety of different sized and shaped work pieces constructed from a variety of different materials. In particular, the cutter (160) may be configured in a variety of different orientations and shapes and may include ridges, teeth or other features for cutting a particular type of material and for making a particular type or size of cut on the work piece. Each of the spot face tool assembly (100), including the spot face connector (120), shaft assembly (140) and cutter (160), are configured to be detachably connected to one another and locked into place for use and then detachably disconnected for storage, cleaning, or for the addition or removal of different sized or shaped spot face connector (120), shaft assembly (140) and cutter (160), to create a variety of different customizable spot face tool assembly. Further, the spot face tool assembly (100), including the spot face connector (120), shaft assembly (140), and cutter (160), may each be detachably connected to one another and locked into place using ridges, ribs, struts or other locking mechanisms known in the art.

The spot face connector (120) includes an open front receiving end (125) and a closed back connecting end (130). The spot face connector (120) is configured for detachably connecting to the shaft assembly (140) and cutter (160). Further in some embodiments, the spot face connector (120) is detachably connected to a pneumatic drill or other automated device for causing the cutter (160) to rotate and cut the spot face on the work site. The open front receiving end (125) for receiving and detachably connecting the shaft assembly (140) and cutter (160). The closed back connecting end (130) for detachably connecting to a pneumatic drill or similar device and for rotating the cutter (160). The shaft assembly (140) includes a stabilizer (145), base (150) and shaft (155). The shaft (155) of the shaft assembly (140) is detachably connected to the open front receiving end (125) of the spot face connector (120). The cutter (160) is detachably connected to the open front receiving end (125) of the spot face connector (120).

In some embodiments, the spot face tool assembly (100) further includes a pneumatic drill (103) detachably connected to the closed back connecting end (130) of the spot face connector (100). Further, in some embodiments of the spot face tool assembly (100) the shaft (155) of the shaft assembly (140) further includes one or more groove (106) embedded therein for detachably connecting the shaft assembly (140) to the spot face connector (120). Further, in some embodiments of the spot face tool assembly (100) the stabilizer (145) of the shaft assembly (140) is threaded. Further, in some embodiments of the spot face tool assembly (100) the cutter (160) is circular.

In some embodiments, the spot face tool assembly (100) includes a spot face connector (120), shaft assembly (140) and cutter (160). The spot face connector (120) having an open front receiving end (125) and a closed back connecting end (130). The open front receiving end (125) having one or more ridge (127) for detachably connecting the cutter (160) thereto and the closed back connecting end (130) for detachably connecting to a pneumatic drill (103). The spot face tool assembly (100) further includes a shaft assembly (140) for stabilizing the spot face tool assembly (100) in a perpendicular position to the work piece (110). The shaft assembly (140) having a threaded stabilizer (145), base (150) and shaft (155). The shaft (155) of the shaft assembly (140) detachably connected to the open front receiving end (125) of the spot face connector (120). The threaded stabilizer (145) configured to be threaded into a threaded opening (109) on the spot face (105) of the work piece (110) to securely stabilize the spot face tool assembly (100) on the work piece (110) in a perpendicular orientation to reduce angling of the spot face tool assembly (100) and reduce angling of the spot face cut (105) thereon when a force is applied to the spot face tool assembly (100) to cut the spot face (105) from a perpendicular orientation. The spot face tool assembly (100) further includes a circular cutter (160) for cutting a spot face (105) on a work piece (110). The circular cutter (160) detachably connected to the open front receiving end (125) of the spot face connector (120). The circular cutter (160) configured for rotating when the spot face connector (120) is detachably connected to a pneumatic drill (103).

The spot face tool assembly (100), including the spot face connector (120), shaft assembly (140) and cutter (160) may each be constructed from any material of sufficient strength necessary for the intended purpose of the spot face assembly (100) and necessary to maintain the structural integrity of the spot face tool assembly (100) when in use. For example, the spot face tool assembly (100), including the spot face connector (120), shaft assembly (140) and cutter (160) may each be constructed from metals such as steel, carbon steel, alloy steel, stainless steel, alloys or other metals, combinations thereof and the like and non-metals such as, plastics, polycarbonate, impact resistant nylon, carbon fiber, polymers, resins, ceramics, composite materials, combinations thereof and the like. It should be understood that the spot face tool assembly (100), including the spot face connector (120), shaft assembly (140) and cutter (160), may each be constructed from the same or different materials. For example, the spot face connector (120) may be constructed from stainless steel, while the shaft assembly (140) is constructed from carbon steel, while the cutter (160) may be constructed from stainless steel, for example.

The spot face tool assembly (100), including the spot face connector (120), shaft assembly (140) and cutter (160), are each configured to be detachably connected to one another and each of the spot face connector (120), shaft assembly (140) and cutter (160) may be constructed in a variety of different sizes, shapes and configurations for use on a variety of different sized and shaped work pieces constructed from a variety of different materials. In particular, the cutter (160) may be configured in a variety of different orientations and shapes and may include ridges, teeth or other features for cutting a particular type of material and for making a particular type or size of cut on the work piece. Each of the spot face tool assembly (100), including the spot face connector (120), shaft assembly (140) and cutter (160), are configured to be detachably connected to one another and locked into place for use and then detachably disconnected for storage, cleaning, or for the addition or removal of different sized or shaped spot face connector (120), shaft assembly (140) and cutter (160), to create a variety of different customizable spot face tool assembly. Further, the spot face tool assembly (100), including the spot face connector (120), shaft assembly (140), and cutter (160), may each be detachably connected to one another and locked into place using ridges, ribs, struts or other locking mechanisms known in the art.

In some embodiments of the spot face assembly (100) the work piece (110) is a heat exchanger (201). Further, in some embodiments of the spot face assembly (100) the threaded opening (109) of the spot face (105) is a plug hole (203) of a heat exchanger (201). In some embodiments of the spot face assembly (100) the shaft assembly (140) is detachably connected to the spot face connector (120) in a fixed position and is not able to rotate in relation to the spot face connector (120).

Referring now to FIG. 16, shown therein is a method (400) of cutting a spot face on a work piece from a perpendicular orientation. The method (400) includes the steps of: (a) providing (410) a spot face tool assembly (100) for cutting a spot face (105) on a work piece (110) from a perpendicular orientation. The spot face tool assembly (100) including a spot face connector (120) having an open front receiving end (125) and a closed back connecting end (130). The spot face tool assembly (100) further including a shaft assembly (140) having a stabilizer (145), base (150) and shaft (155). The shaft (155) of the shaft assembly (140) detachably connected to the open front receiving end (125) of the spot face connector (120). The spot face tool assembly (100) further includes a cutter (160) detachably connected to the open front receiving end (125) of the spot face connector (120). The method (400) further includes the steps of (b) connecting (420) the closed back connecting end (130) of the spot face connector (120) to a pneumatic drill (103); and (c) inserting (430) the stabilizer (145) of the shaft assembly (140) into an opening (109) on the spot face (105) of the work piece (110) to stabilize the spot face tool assembly (100) in a perpendicular orientation on the work piece (110). Further, the method (400) further includes the step of (d) cutting (440) a spot face (105) on the work piece (110) from a perpendicular orientation while the stabilizer (145) of the shaft assembly (140) is inserted into the opening (109) of the spot face (105) on the work piece (110).

The spot face tool assembly (100), including the spot face connector (120), shaft assembly (140) and cutter (160) may each be constructed from any material of sufficient strength necessary for the intended purpose of the spot face assembly (100) and necessary to maintain the structural integrity of the spot face tool assembly (100) when in use. For example, the spot face tool assembly (100), including the spot face connector (120), shaft assembly (140) and cutter (160) may each be constructed from metals such as steel, carbon steel, alloy steel, stainless steel, alloys or other metals, combinations thereof and the like and non-metals such as, plastics, polycarbonate, impact resistant nylon, carbon fiber, polymers, resins, ceramics, composite materials, combinations thereof and the like. It should be understood that the spot face tool assembly (100), including the spot face connector (120), shaft assembly (140) and cutter (160), may each be constructed from the same or different materials. For example, the spot face connector (120) may be constructed from stainless steel, while the shaft assembly (140) is constructed from carbon steel, while the cutter (160) may be constructed from stainless steel, for example.

The spot face tool assembly (100), including the spot face connector (120), shaft assembly (140) and cutter (160), are each configured to be detachably connected to one another and each of the spot face connector (120), shaft assembly (140) and cutter (160) may be constructed in a variety of different sizes, shapes and configurations for use on a variety of different sized and shaped work pieces constructed from a variety of different materials. In particular, the cutter (160) may be configured in a variety of different orientations and shapes and may include ridges, teeth or other features for cutting a particular type of material and for making a particular type or size of cut on the work piece. Each of the spot face tool assembly (100), including the spot face connector (120), shaft assembly (140) and cutter (160), are configured to be detachably connected to one another and locked into place for use and then detachably disconnected for storage, cleaning, or for the addition or removal of different sized or shaped spot face connector (120), shaft assembly (140) and cutter (160), to create a variety of different customizable spot face tool assembly. Further, the spot face tool assembly (100), including the spot face connector (120), shaft assembly (140), and cutter (160), may each be detachably connected to one another and locked into place using ridges, ribs, struts or other locking mechanisms known in the art.

In some embodiments of the method (400) of cutting a spot face on a work piece from a perpendicular orientation the work piece (110) is a heat exchanger (201). Further, in some embodiments of the method (400) of cutting a spot face (105) on a work piece (110) from a perpendicular orientation the stabilizer (145) is threaded. Further, in some embodiments of the method (400) of cutting a spot face (105) on a work piece (110) from a perpendicular orientation the opening (109) on the spot face (105) of the work piece (110) is threaded. Further, in some embodiments of the method (400) of cutting a spot face (105) on a work piece (110) from a perpendicular orientation the threaded opening (109) of the spot face (105) is a plug hole (203) of a heat exchanger (201). In some embodiments of the method (400) of cutting a spot face (105) on a work piece (110) from a perpendicular orientation the shaft assembly (140) is detachably connected to the spot face connector (120) in a fixed position and is not able to rotate in relation to the spot face connector (120).

It is to be appreciated that embodiments of the inventive concepts disclosed herein may be shipped fully or partially assembled, or fully or partially disassembled in the form of a kit, as will be readily appreciated by persons of ordinary skill in the art having the benefit of the instant disclosure.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. A spot face tool assembly for cutting a spot face on a work piece from a perpendicular orientation, the spot face tool assembly comprising:
a spot face connector having an open front receiving end and a closed back connecting end;
a shaft assembly having a stabilizer, base and shaft, the shaft of the shaft assembly detachably connected to the open front receiving end of the spot face connector; and
a cutter detachably connected to the open front receiving end of the spot face connector.

2. The spot face tool assembly of claim 1 further comprising a pneumatic drill detachably connected to the closed back connecting end of the spot face connector.

3. The spot face tool assembly of claim 1 wherein the shaft of the shaft assembly further comprises one or more groove embedded therein for detachably connecting the shaft assembly to the spot face connector.

4. The spot face tool assembly of claim 1 wherein the stabilizer of the shaft assembly is threaded.

5. The spot face tool assembly of claim 1 wherein the cutter is circular.

6. A spot face tool assembly for cutting a spot face on a work piece from a perpendicular orientation, the spot face tool assembly comprising:
a spot face connector for detachably connecting a cutter and a pneumatic drill, the spot face connector having an open front receiving end and a closed back connecting end, the open front receiving end having one or more ridge for detachably connecting a cutter thereto and the closed back connecting end for detachably connecting a pneumatic drill;
a shaft assembly for stabilizing the spot face tool assembly in a perpendicular position to the work piece, the shaft assembly having a threaded stabilizer, base and shaft, the shaft of the shaft assembly detachably connected to the open front receiving end of the spot face connector, the threaded stabilizer configured to be threaded into a threaded opening on the spot face of the work piece to securely stabilize the spot face tool assembly on the work piece in a perpendicular orientation and to reduce angling of the spot face tool assembly and angling of the spot face cut thereon when a force is applied to the spot face tool assembly to cut the spot face from a perpendicular orientation; and
a circular cutter for cutting a spot face on a work piece, the circular cutter detachably connected to the open front receiving end of the spot face connector, the circular cutter configured for rotating about the spot face connector when the spot face connector is detachably connected to a pneumatic drill.

7. The spot face assembly of claim 6 wherein the work piece is a heat exchanger.

8. The spot face assembly of claim 6 wherein the threaded opening of the spot face is a plug hole of a heat exchanger.

9. The spot face assembly of claim 6 wherein the shaft assembly is detachably connected to the spot face connector in a fixed position and is not able to rotate in relation to the spot face connector.

10. A method of cutting a spot face on a work piece from a perpendicular orientation, the method comprising the steps of:
providing a spot face tool assembly for cutting a spot face on a work piece from a perpendicular orientation, the spot face tool assembly comprising:
a spot face connector having an open front receiving end and a closed back connecting end;
a shaft assembly having a stabilizer, base and shaft, the shaft of the shaft assembly detachably connected to the open front receiving end of the spot face connector; and
a cutter detachably connected to the open front receiving end of the spot face connector;
connecting the closed back connecting end of the spot face connector to a pneumatic drill;
inserting the stabilizer of the shaft assembly into an opening on the work piece to stabilize the spot face tool assembly in a perpendicular orientation on the work piece; and
cutting a spot face on the work piece from a perpendicular orientation while the stabilizer of the shaft assembly is inserted into the opening on the work piece.

11. The method of cutting a spot face on a work piece from a perpendicular orientation of claim 10 wherein the work piece is a heat exchanger.

12. The method of cutting a spot face on a work piece from a perpendicular orientation of claim 10 wherein the stabilizer is threaded.

13. The method of cutting a spot face on a work piece from a perpendicular orientation of claim 10 wherein the opening on the work piece is threaded.

14. The method of cutting a spot face on a work piece from a perpendicular orientation of claim 10 wherein the threaded opening of the spot face is a plug hole of a heat exchanger.

15. The method of cutting a spot face on a work piece form a perpendicular orientation of claim 10 wherein the shaft assembly is detachably connected to the spot face connector in a fixed position and is not able to rotate in relation to the spot face connector.
